(19) United States
(12) Patent Application Publication
(10) Pub. No.: US 2011/0277520 A1
(43) Pub. Date: Nov. 17, 2011

(54) ELECTRONIC DEVICE FOR A MECHANICAL BLOCKING.

(76) Inventor: Martyn Sergeevich Nunuparov, Moscow (RU)

(21) Appl. No.: 13/144,583

(22) PCT Filed: Jan. 11, 2010
(86) PCT No.: PCT/RU10/00004

§ 371 Date: Jul. 14, 2011

(30) Foreign Application Priority Data
Jan. 14, 2009 (RU) 2009-100897

(51) Int. Cl. E05B 47/02; E05B 47/00

(52) U.S. Cl. 70/276; 70/277

(57) ABSTRACT

An electronic device for a mechanical blocking and power mechanisms on its basis, intended for use in electronic locks, hydraulic/pneumatic automation, electronically controlled valve(tap), electronically controlled power electrical switches and commutators, electro-mechanical clutches and couplings, etc. The devices based on invention are compact, have a simple design and are rather reliable in conditions of shocks and vibrations. Low electric power consumption and corresponding long battery life have been obtained at the prototypes of these devices. It will be effectively used in the systems of autonomous access control.

### FIELD OF TECHNOLOGY

The present invention relates to electromechanics and more specifically to the devices for electromechanical locking engagement, electronically controlled motion transfer mechanisms or assemblies. It can be also be used as an independent unit in appliances, instruments and automation systems for various applications. The preferential use of the invention in a devices, such as the electronic locks or other security locking mechanism, where electronic control is associated with the need to control user access rights. Also, the invention will be effective for use in blocking electrical, pneumatic and hydraulic devices, electronic couplings, clutches, etc.

### PRIOR ART

Various mechanical devices for blocking, gearing and motion transmission in which the plunger movement is fixed in the body by means of the ball joint [see for example, patents RU2184284, 2002 Jun. 27; RU2295621, 2007 Mar. 20; RU2304247, 2007 Aug. 10; U.S. Pat. No. 5,141,355, 1992 Aug. 25] are known from the technical publications. In these devices, the lock balls (rollers) joint can be installed in a position where the plunger and body are locked in a reciprocal movement. Such mechanical locking devices are widely used in the latching mechanism, clutches, couplings etc.

With the development of automation, and in particular, the electronic control mechanisms, these mechanical joints have been added by electromechanical actuators (solenoids, electric motors) for moving the control elements of the joints [see for example, patent RU2063505, 1996 Jul. 10; U.S. Pat. No. 6,474,122, 2002 Nov. 5; U.S. Pat. No. 6,125,673, 2000 Oct. 3]. Such known devices have several disadvantages. Devices that use solenoids with longitudinally spring-loaded control element are unreliable against the vibrations or shocks along the axis of the solenoid. These vibrations and shocks can lead to unlocking of the device. Also, actuators and their electronic control units are often located at the stationary body of the device [see For example, U.S. Pat. No. 4,807,454, 1989 Feb. 28], which leads to an increase of the device sizes or complicates the user interface. In particular, the plungers in such devices have relatively few degrees of freedom, which limit the options for the application of known technical solutions.

### DISCLOSURE OF INVENTION

The aim of the present invention is to provide a compact electronic device for a mechanical blocking with low power consumption for a wide range of applications and in particular, for the locking system with electronically controlled user access. An important condition for saving the energy in the electromechanical locking device is a need to release control element of fixing means from the other load elements in fixing means at least at the moment when control element is forced by an actuator. To make it happen, the moment of said release (unload) of control element should concurs with the moment when electronic unit sends commands to move actuator.

This goal is achieved by an electronic device for mechanically blocking that comprises body and a movable blocking means (for example, in the form of plunger) installed in the body with the ability for rotation and/or longitudinal movement of the body, fixing means designed to secure the blocking means in the body, control element of the fixing means, kinematically connected with the power elements of fixing means and having at least two fixed positions, which is moved by the actuator located in the movable blocking means by the commands from the electronic unit electrically connected to the actuator. In order to increase the reliability of an actuator operation said electronic device for mechanical blocking additionally comprises an electronic sensor allowing the electronic unit to determine the moment when control element is mechanically released from the load of other elements.

The structure of the claimed electronic blocking device can be made rather simple when an actuator, control element and, if necessary, an electronic unit will be mounted in the movable blocking means.

To switch the device from the “locked” state into the “unlocked” state or vice versa movable blocking means should be mechanically pre-installed in a certain position in which the control element of fixing means is released (unloaded) from the power mechanical loads of other parts of fixing means. This moment can be detected by an electronic sensor and allows to the electronic unit synchronously issue a control command to the actuator to move the control element. This method considerably increases reliability of actuator operation and reduces the power consumption required for actuator.

Various devices can be selected as an actuator like: solenoids, motors, piezoactuators, electrostatic mechanisms, etc.

If one chooses an electric motor, the control element which is kinematically coupled to the elements of fixing means (for example balls) can be made as a rotatable cam mounted on a motor shaft or a conical-cylindrical sleeve connected to the motor shaft as a screw pair with reciprocal movement while motor shaft rotates.

To provide an additional stability to control element in the extreme fixed positions relative to the shock and vibration device may further comprise a resilient element (spring), mounted at the blocking means and kinematically associated with the control element.

The proposed device is highly effective for the use in electronic locks that require user identification. In these applications, the electronic unit of the proposed electromechanical blocking devices may further comprise an electronic interface unit to exchange information and/or energy with the external electronic devices—electronic keys, programmers and other computerized means.

Interface unit can be arranged to exchange information/energy in various channels of communication—radio, optical channel, acoustic channel, and in particular, with the ability to recognize images, signal sequences, biometrics, kriptoprotocols.

It is particularly effective for the user to manage special scenarios to manipulate with an electronic lock, built on the base of the proposed blocking devices. At one of these possible scenarios a preset moment of movable blocking means in position required to switch-over actuator and the moment of reading the user code information, should be synchronized. This synchronization is provided by the mentioned above position control electronic sensor. For example, the interface unit mounted on the outer edge (faceplate) of movable blocking means is configured to recognize the persons fingerprint pattern. So that when one press on the interface unit of blocking means by the finger and place it into a special preset position of blocking means then the electronic unit will read the fingerprint image and produces an appropriate command for the actuator.

Thus, a simple and natural user manual manipulation can take all the necessary movements in the device and lead to the execution of its functions.

Despite the simplicity of the claimed device, it allows to build a wide variety of automation devices on its basis.

The device may be designed in the form of power locking device with an electronic control, and in particular, with an electronic access control, where certain position of blocking means will determine the lock status of the locking mechanism—“locked”/“unlocked.” Areas of use—electronic locks, etc.

The device may be designed in the form of the electronically controlled valve(tap) for liquids or gases, and in particular, with user access control, where certain position of blocking means will determine the valve(tap) status—“Open”/“Closed”. Applications—Hydraulic or pneumatic devices.

The device may be designed in the form of a power electric switch with an electronic control and in particular, user access control, where certain position of blocking means will determine the electrical switch status—“Switch-On”/“Switch-Off”. It can be used in electric systems to prevent unauthorized switching.

The device may be designed in the form of electronically controlled clutch to control the no transmission of rotational motion from the driving element that has a cylindrical shank to the driven shaft. Both driving and driven elements are coaxially aligned at the common outer housing and kinematically associated with the movable blocking means and special clutch key. When one moves blocking means from one fixed position to another key will “lock”/“unlock” a power joint of cylindrical shank and the driven shaft. Such a device could be used in a system of electronic locks, in particular, as electronically controlled cylindrical lock handle, in which the electronic unit has the user access control features.

Also, the specified device can be used in the other various automatic clutch devices.

### BRIEF DESCRIPTION OF DRAWINGS

The following drawings illustrates some embodiments of the invention, which at the same time does not cover a large variety of other forms of implementation of the inventive concept.

FIG. 1a, FIG. 1b—an electronic blocking device in the “unlocked” and “locked” states, respectively;

FIG. 2a, FIG. 2b, FIG. 2c—blocking assembly with the rotatable cam control element;

FIG. 3a, FIG. 3b—blocking assembly with the conical-cylindrical control element;

FIG. 4a, FIG. 4b—an electronic blocking device designed as a power locking mechanism;

FIG. 5a, FIG. 5b—an electronic blocking device designed as a valve(tap);

FIG. 6a, FIG. 6b—an electronic blocking device designed as a power electric switch;

FIG. 7a, FIG. 7b—an electronic blocking device designed as a clutch mechanism with controlled power key.

### DETAILED DESCRIPTION

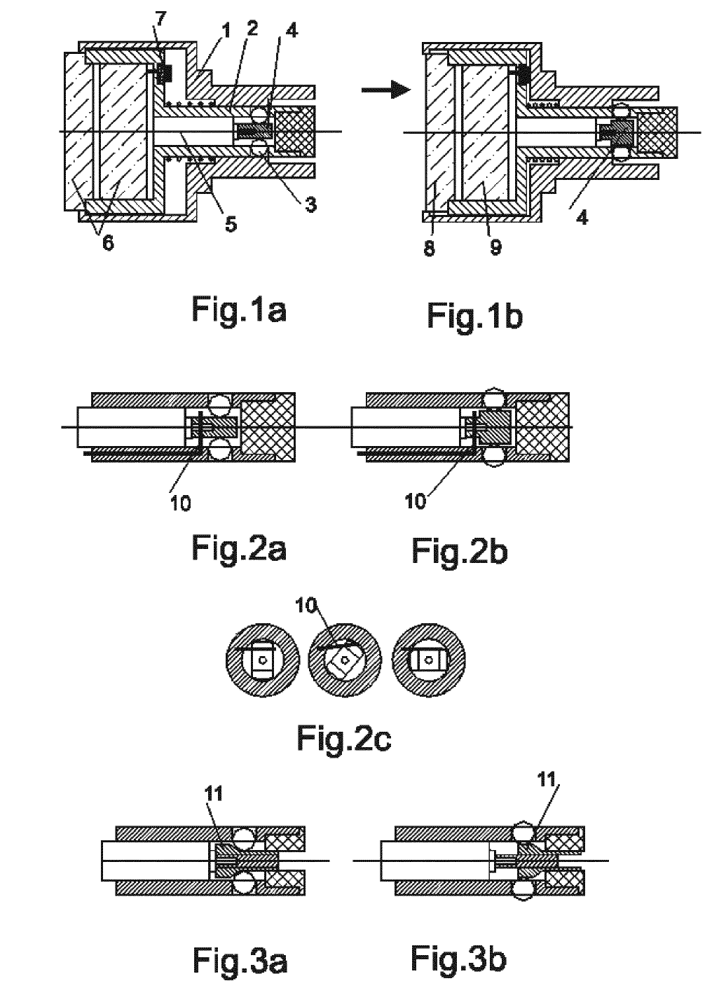

According to present invention, the electromechanical blocking device (see FIG. 1a,b) comprises a body 1, a blocking means mounted in the body 1 with ability for rotation and longitudinal movement. Fixing means 3 mounted in the movable blocking means 2 and designed as for blocking of movement at fixed position of movable blocking means 2 in the body 1. Actuator 5 is also mounted in the blocking means 2, designed to mechanically control the position of control element 4, which is kinematically associated with the elements (balls or rollers) of fixing means 3. Control element 4 can be moved by actuator 5 between two fixed and stable positions.

Actuator 5 is managed by the commands from the electronic unit 6 which is electrically connected to the actuator 5 and if necessary, also placed in the blocking means 2. In order to synchronize moment of switching of actuator 5 the electronic sensor 7, placed into device, which allows to determine the moment of kinematic release (unload) of control element 4 from the balls 3. The sensor 7 can also be installed in the blocking means 2 and in its simplest variant it can be designed as an electric tact button connected to the electronic unit 6.

Electronic unit 6 may have a complicated structure and, in particular, contain an electronic interface 8 to exchange of information/energy with the external devices and the actuator control unit 9. If necessary, an electronic interface 8 may be implemented with the function of code information recognition from the external electronic devices to control user access when the device is initiated to change the states “blocked”/“unlocked.”

When actuator 5 realized in the form of motor, the control element 4 can be made in the form of cam mounted on the motor shaft (see FIG. 2a,b). The transition of control element (cam) 4 from one fixed position to another results from said shaft rotation. Fixed positions of the cam 4 kinematically determine the positions of the elements of fixing means 3 (balls or rollers).

To ensure stability of the cam 4 in the fixed positions against shocks or vibrations resilient element, such as a spring 10 may be placed in the blocking means 2, which prevents the spontaneous rotation of the control element 4 (see FIG. 2c).

The control element 4 can also be designed as a conical-cylindrical sleeve 11 (see FIG. 3a,b) which is connected to the motor shaft by the screw pair. The transition of the control element from one fixed position to another occurs through its reciprocating motion in which it can push out the elements of fixing means 3 (balls or rollers). This solution provides stable enough positions of the control element 4 (conical sleeve), although the movement of such control element requires a relatively high electric power 170 consumption.

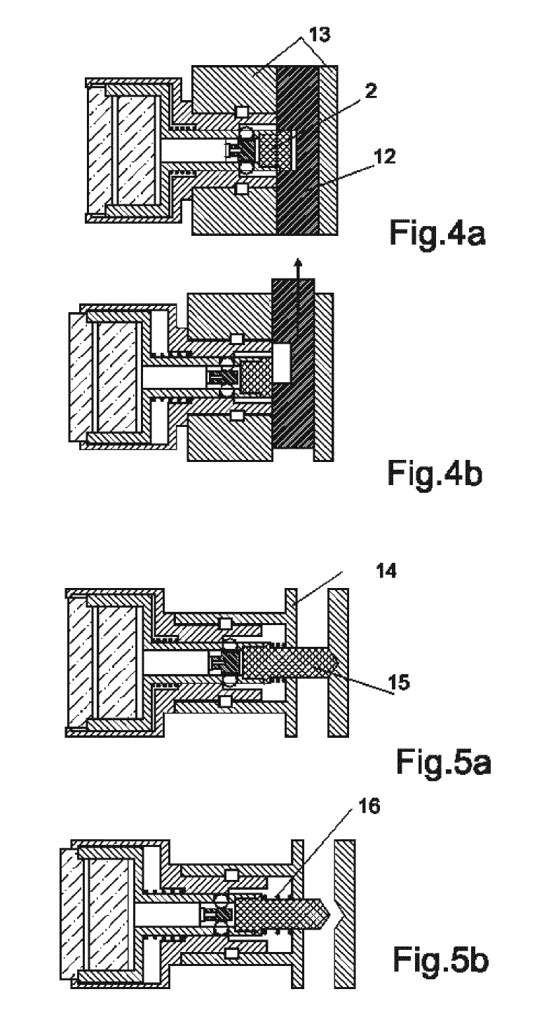

FIG. 4a, b shows one of possible embodiments of the locking device with a movable bolt 12, where claimed blocking device has a common housing 13 with a locking device and blocking means 2 is used to block the movement of bolt 12 in the housing 13. Implementation of the claimed device in the form of the electronically controlled valve 175 (tap) for liquids or gases are shown in the FIG. 5a,b. The body of blocking device 1 is added by the housing with the tube 14. The plug 15 is attached to the movable blocking means 2. Changing the fixed position of blocking means determines the state of the plug 15 and cause the “Open”/“Closed” states of the tube valve(tap). To ensure a reliable return of the plug 15 additional return spring 16 is provided in said electronic no valve(tap) design.

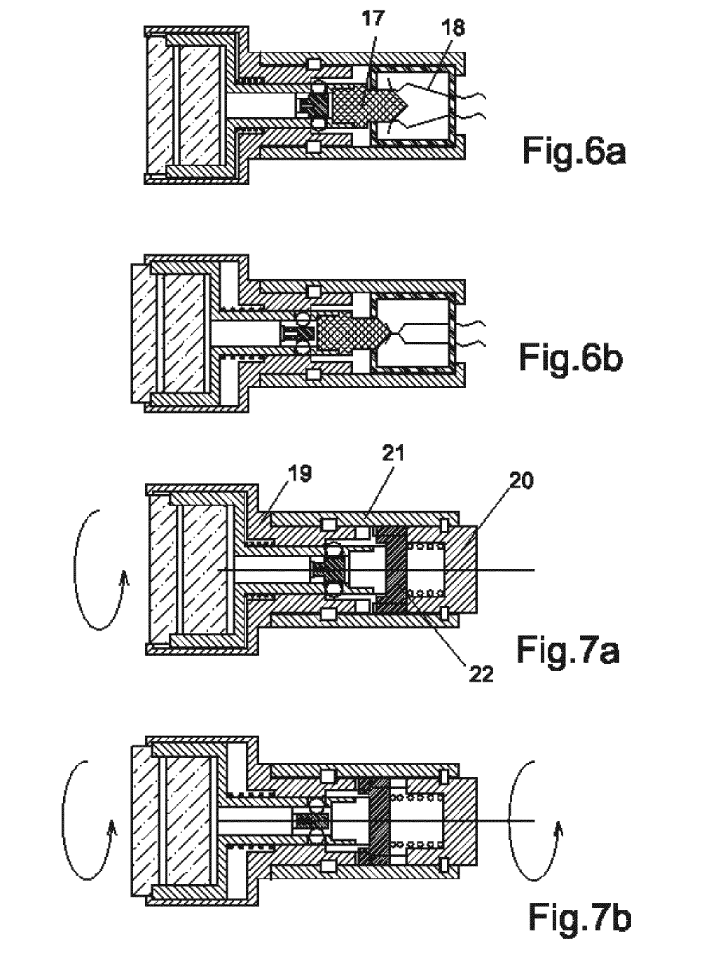

Implementation of the claimed device in the form of a power electric switch (electric power break button) with an electronic control is shown at the FIG. 6a,b. As seen from this schematic drawing, change of the fixed position of movable blocking means and the associated dielectric contacts breaker 17 determines the state of the switch's electrical 185 contacts 18—“Switch-Off” or “Switch-ON”.

FIG. 7 shows a variant of the device in the mechanism of electronically controlled clutch to transmit rotary motion from the body 1 having a cylindrical shank 19 to the driven shaft 20 installed coaxially in the common housing 21. The driven shaft 20 has a special spring-loaded key 22 which is kinematically interfere with the movable blocking means 2. When one move a blocking means 2 to the right or to the left fixed positions key 22 can “lock”/“unlock” a power joint of the cylindrical shank 19 and the driven shaft 20 allowing the transfer of power rotation between them.

The operation of the proposed electromechanical blocking devices is illustrated at the FIG. 1,2,3, as follows:

In the “unlocked” state of the device the control element (cam) 4 is in a position where it does not hinder the full deployment of the elements (balls) of fixing means 3 in the slot of blocking means 2 (see FIG. 1, FIG. 2, FIG. 3a). Balls 3 are hidden in the blocking means 2 and it can freely move in the body 1.

To enable the “locked” state of the device the blocking means 2 should be slightly 200 moved to the right position. In this special preset position the balls of fixing means 3 can freely move out of the slot of blocking means and does not restrict or load the movement (rotation) of control element (cam) 4. So that actuator does not need much power to rotate cam 4.

The shift of the blocking means 2 in said preset position, where balls 3 are released 205 (unloaded) and actuator 5 can be moved is determined by the electronic sensor 7. So that when sensor in the form of button 7 is pressed by the elements of the device it creates a signal to an electronic unit 6 to switch over actuator 5. Actuator 5 then moves an unload control element 5 from one of it stable position (see FIG. 1b, FIG. 2b, FIG. 3b), into another stable position where the balls 3 are ejected from the slot of blocking 210 means 2. When movable blocking means 2 goes to the left from preset position balls 3 enter into engagement with the hard edge of the body 1 and blocking means 2 appears to be fixed (see FIG. 1b) from further movement to the left. However, this small offset of the blocking means 2 to the left is enough to switch-off the sensor 7.

To change the device states from the “blocked” into the “unblocked” state blocking 215 means 2 should again be placed into an preset right position in which the sensor 7 is switched-on again and creates signal to the electronic unit 6 that the moment (position) when cam 4 is unload from the balls 3 happens, and if necessary, the actuators can turn the cam 5 to “unlocked” state.

Prototypes of an electromechanical blocking devices and a variety of mechanisms 220 based on it have been developed. Experimental verification confirmed the high efficiency of the claimed technical solutions. The devices are compact, have a simple design and are rather reliable in conditions of shocks and vibrations. Low electric power consumption and corresponding long battery life have been obtained at these devices.

1. An electronic device for a mechanical blocking that comprises:
a body and a movable blocking means installed in the body with the ability for rotation and/or longitudinal movement in the said body,
a fixing means with a power elements designed to secure the blocking means in the body,
a control element of the fixing means, kinematically associated with the power elements of said fixing means and having at least two fixed positions, which is movable by the actuator also located in the blocking means,
an electronic unit that controls said actuator by the electronic commands,
and an electronic sensor allowing the electronic unit to determine the moment when control element is mechanically released from the load of the elements of fixing means.

2. The device according to claim 1, wherein the actuator is selected from the group: an electric motor, an electromagnetic solenoid, a piezoelectric actuator.

3. The device according to claim 1, wherein the actuator is selected as an electric motor and a control element is designed as a rotatable cam fixed on the shaft of said motor.

4. The device according to claim 1, wherein the actuator is selected as an electric motor and a control element is associated with a screw pair mounted on a shaft of the motor and the reciprocating movement of control element is ensured by the rotation of the motor shaft.

5. The device according to claim 1, which further additionally comprises a resilient element, mounted at the blocking means and kinematically associated with the control element to stabilize the control element in the fixed positions against vibrations and shocks.

6. The device according to claim 1, wherein the electronic unit is placed in the movable blocking means.

7. The device according to claim 1, wherein the electronic unit comprises an interface unit for exchanging information, and in particular, user access control information and/or energy with the external electronic device and a unit to control said actuator.

8. The device according to claim 7, wherein the interface unit is configured to communicate with users via various communication channels—radio, optical channel, acoustic channel, and in particular, with the ability to recognize images, signal sequences, biometrics, kriptosignal exchange.

9. The device according to claims 1-8, which further additionally connected to a mechanism that can be blocked with the help of mentioned movable blocking means.

10. The device of claim 9, made in the form of the electronically controlled power locking mechanism, where changes of a fixed position of the movable blocking means determines the state of the locking mechanism—“blocked”/“unlocked.”

11. The device according to claim 9, made in the form of the electronically controlled valve (tap) for liquids or gases, where changes of a fixed position of movable blocking means determines the state of the valve (tap)—“Open”/“Closed”.

12. The device according to claim 9, made in the form of the electronically controlled electric power switch where changes of a fixed position of the movable blocking means determines the state of the said electric switch—“Switched ON”/“Switched OFF”

13. The device of claim 9, made in the form of the electronically controlled power clutch to transmit rotary motion from the driving means with a cylindrical shank to the driven shaft, installed coaxially in the common housing, which additionally comprises spring-loaded power key to connect or disconnect driving shank and driven shaft and which position is determined by kinematically associated with it movable blocking means of said device.
